(19) United States
(12) Patent Application Publication
(10) Pub. No.: US 2026/0228408 A1
(43) Pub. Date: Aug. 6, 2026

(54) ELECTRONIC DEVICE AND METHOD FOR GENERATING COMPACT MODEL OF SEMICONDUCTOR DEVICE INCLUDING TWO-DIMENSIONAL MATERIAL AND CONTACT METAL

(71) Applicants: Samsung Electronics Co., Ltd., Suwon-si (KR); RESEARCH & BUSINESS FOUNDATION SUNGKYUNKWAN UNIVERSITY, Gyeonggi-do (KR)

(72) Inventors: Jaewoo SHIM, Suwon-si (KR); Jongwook JEON, Suwon-si (KR); Hanggyo JUNG, Suwon-si (KR); Sangwon KIM, Suwon-si (KR); Hyeongseok JANG, Suwon-si (KR); Yoonhoo HA, Suwon-si (KR); Jinhong PARK, Suwon-si (KR)

(73) Assignees: Samsung Electronics Co., Ltd., Suwon-si (KR); RESEARCH & BUSINESS FOUNDATION SUNGKYUNKWAN UNIVERSITY, Gyeonggi-do (KR)

(21) Appl. No.: 19/460,825

(22) Filed: Jan. 27, 2026

(30) Foreign Application Priority Data
Feb. 6, 2025 (KR) 10-2025-0015291

(51) Int. Cl. G06F 30/392

(52) U.S. Cl. CPC G06F 30/392

(57) ABSTRACT

Provided are an electronic device and a method for generating a compact model of a semiconductor device including a two-dimensional material and a contact metal. A processor of the electronic device, generates, a current model based on design parameters, the design parameters including contact type of the two-dimensional material and the contact metal, and the current model corresponding to the contact type, generates a contact resistance model based on the current model, and generates a compact model of the semiconductor device based on the contact resistance model.

### CROSS-REFERENCE TO RELATED APPLICATION

This application is based on and claims priority under 35 U.S.C. § 119 to Korean Patent Application No. 10-2025-0015291, filed on Feb. 6, 2025, in the Korean Intellectual Property Office, the disclosure of which is incorporated by reference herein in its entirety.

### BACKGROUND

### 1. Field

The disclosure relates to modeling of a semiconductor device. More specifically, the disclosure relates to a method of accurately modeling a semiconductor device by considering contact resistance.

### 2. Description of the Related Art

In circuit design of semiconductor devices, a compact model is beneficial to accurately predict and describe the electrical characteristics that occur between a source and a drain according to an external signal. In particular, the latest semiconductor designs using nanometer-level processes consider various physical characteristics that occur with scaling down, such as short channel effects. As a representative example, a Berkeley Short-channel insulated gate field-effect transistor (IGFET) model (BSIM) may be used for integrated circuit design and simulation that reflects design parameters and three-dimensional structures.

As semiconductor devices continue to become smaller, the influence of contact resistance may become more important. However, the BSIM may have a limitation in that contact resistance may be difficult to physically represent in detail. More specifically, in the BSIM, contact resistance may simply be expressed as a constant, which may not sufficiently reflect the complex effects of actual contact resistance on circuit performance. Therefore, alternative models are being explored.

### SUMMARY

Provided are an electronic device and method for generating a compact model of a semiconductor device including a two-dimensional material and a contact metal.

Additional aspects will be set forth in part in the description which follows and, in part, will be apparent from the description, or may be learned by practice of the presented embodiments of the disclosure.

According to an aspect of the disclosure, an electronic device for generating a compact model of a semiconductor device including a two-dimensional material and a contact metal is provided.

The electronic device includes a memory storing one or more instructions, and one or more processors configured to execute one or more instructions stored in the memory, wherein the one or more processors are configured to, by executing the one or more instructions, generate a current model based on design parameters, the design parameters including a contact type of the two-dimensional material and the contact metal and obtained from a layout file of the semiconductor device or a user input and the current model corresponding to the contact type of the two-dimensional material and the contact metal, generate, based on the current model, a contact resistance model of the two-dimensional material and the contact metal, the contact resistance model having a voltage applied to the semiconductor device as an independent variable, and generate, based on the contact resistance model, the compact model of the semiconductor device, the compact model including response characteristics of contact resistance of the two-dimensional material and the contact metal according to the voltage applied to the semiconductor device.

In at least one example embodiment, the contact type may include at least one of a top contact in which the contact metal is in contact with a surface of the two-dimensional material, an edge contact in which the contact metal is in contact with an edge of the two-dimensional material, or a hybrid contact in which the top contact and the edge contact are hybridized.

In at least one example embodiment, the one or more processors may be configured to, by executing the one or more instructions, generate a tunneling current model corresponding to the contact type of the two-dimensional material and the contact metal, generate a thermionic current model corresponding to the contact type of the two-dimensional material and the contact metal, and generate the current model from the tunneling current model and the thermionic current model.

In at least one example embodiment, the one or more processors may be configured to, by executing the one or more instructions, generate the current model based on layout parameters regarding a contact shape of the two-dimensional material and the contact metal, wherein the layout parameters include at least one of a contact length or a contact area of the two-dimensional material and the contact metal.

In at least one example embodiment, the one or more processors may be configured to, by executing the one or more instructions, generate the current model based on the design parameters differentiated according to the contact type.

In at least one example embodiment, the one or more processors may be configured to, by executing the one or more instructions, generate the contact resistance model based on the design parameters differentiated according to the contact type.

In at least one example embodiment, when the contact type of the two-dimensional material and the contact metal includes a top contact, the design parameters may include a van der Waals gap (vdW gap), a Schottky barrier height (SBH), and a contact area of the two-dimensional material and the contact metal.

In at least one example embodiment, when the contact type of the two-dimensional material and the contact metal includes an edge contact, the design parameters may include a Schottky barrier height and a contact length of the two-dimensional material and the contact metal.

In at least one example embodiment, the two-dimensional material may include a transition metal dichalcogenide (TMDC).

In at least one example embodiment, the contact metal may include at least one of a single material or a compound.

According to another aspect of the disclosure, a method of generating a compact model of a semiconductor device including a two-dimensional material and a contact metal is provided.

The method is performed by one or more processors, and the method includes generating a current model based on design parameters, the design parameters including a contact type of the two-dimensional material and the contact metal and obtained from at least one of a layout file of the semiconductor device or a user input, and the current model corresponding to the contact type of the two-dimensional material and the contact metal, generating, based on the current model, a contact resistance model of the two-dimensional material and the contact metal, the contact resistance model having a voltage applied to the semiconductor device as an independent variable, and generating, based on the contact resistance model, a compact model of the semiconductor device, the compact model including response characteristics of contact resistance of the two-dimensional material and the contact metal according to the voltage applied to the semiconductor device.

In at least one example embodiment, the contact types may include at least one of a top contact in which the contact metal in contact with a surface of the two-dimensional material, an edge contact in which the contact metal is in contact with an edge of the two-dimensional material, or a hybrid contact in which the top contact and the edge contact are hybridized.

In at least one example embodiment, the generating the current model may include generating a tunneling current model corresponding to the contact type of the two-dimensional material and the contact metal, generating a thermionic current model corresponding to the contact type of the two-dimensional material and the contact metal, and generating the current model from the tunneling current model and the thermionic current model.

In at least one example embodiment, the generating the current model may include generating the current model based on layout parameters regarding a contact shape of the two-dimensional material and the contact metal, wherein the layout parameters include at least one of a contact length or a contact area of the two-dimensional material and the contact metal.

In at least one example embodiment, the generating of the current model may include generating the current model based on the design parameters differentiated according to the contact type.

In at least one example embodiment, the generating of the contact resistance model may include generating the contact resistance model based on the design parameters differentiated according to the contact type.

According to another aspect of the disclosure, provided is a computer-readable recording medium having recorded thereon a program for causing the method to execute on a computer, the method of generating a compact model of a semiconductor device including a two-dimensional material and a contact metal.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows voltage-current graphs of a metal-oxide-semiconductor field-effect transistor (MOSFET) according to at least one example embodiment;

FIG. 2 illustrates contact types of example semiconductor devices according to some example embodiments;

FIG. 3 is a block diagram of an electronic device according to at least one example embodiment;

FIG. 4 is a flowchart of a method of generating a compact model of a semiconductor device, according to at least one example embodiment;

FIG. 5 is a flowchart of a method of simulating a semiconductor device, according to at least one example embodiment;

FIG. 6 illustrates design parameters according to at least one example embodiment;

FIG. 7 illustrates a layout file according to at least one example embodiment;

FIG. 8 illustrates a compact model of a semiconductor device, according to at least one example embodiment;

FIG. 9 is a circuit diagram of a semiconductor device according to at least one example embodiment;

FIGS. 10 and 11 illustrate application examples of a contact resistance model; and

FIG. 12 illustrates performance of a compact model of a semiconductor device, according to at least one example embodiment.

### DETAILED DESCRIPTION

Reference will now be made in detail to embodiments, examples of which are illustrated in the accompanying diagrams, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The terms used in the present specification will be briefly explained, and the disclosure will be described in detail. In the disclosure, the expression “at least one of a, b, or c” may refer to “a”, “b”, “c”, “a and b”, “a and c”, “b and c”, “all of a, b, and c”, and/or variations thereof.

The terms used in this disclosure are selected from commonly used terms as much as possible while considering the functions of this disclosure, but these may vary depending on the intention of engineers working in the field, precedents, the emergence of new technologies, etc. Additionally, in certain cases, there are terms arbitrarily selected by the applicant, and in such cases, their meanings will be described in detail in the relevant description section. Therefore, the terms used in the disclosure should be defined based on the meaning of the terms and the overall details of the disclosure, rather than simply the names of the terms.

A singular expression may include a plural expression unless the context clearly indicates otherwise. The terms used herein, including technical or scientific terms, may have the same meaning as commonly understood by one of ordinary skill in the art described herein. Additionally, the terms including ordinal numbers, such as ‘first’ or ‘second,’ used herein may be used to describe various components, but the components should not be limited by the terms. The above terms are used solely to distinguish one component from another.

Throughout the specification, when a part is described as “including” a component, this does not mean that the part excludes other components, but rather that the part may include other components, unless otherwise stated.

Also, through the specification, functional units, such as processors, that are configured process at least one function or operation may be implemented as processing circuitry, such as hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc., and/or electronic circuits including said components.

In the disclosure, a ‘semiconductor device’ may refer to a switching device including a channel of a two-dimensional material and an electrode of a metal in contact with the two-dimensional material. For example, a ‘semiconductor device’ may refer to metal-oxide-semiconductor field-effect transistor (MOSFET) that includes a two-dimensional material and a contact metal.

Hereinafter, various embodiments of the disclosure are described with reference to the attached drawings.

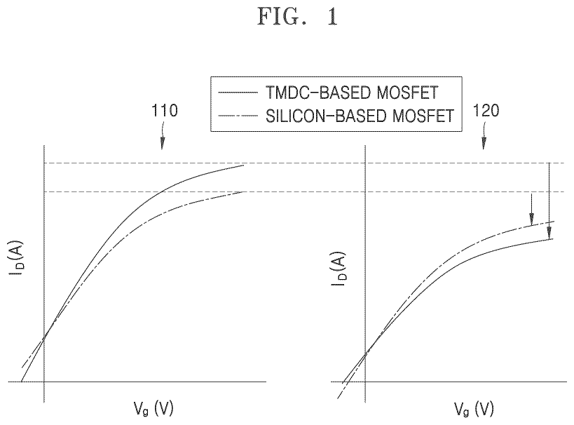

FIG. 1 shows current-voltage graphs 110 and 120 of a MOSFET according to at least one example embodiment.

Silicon-based semiconductor technology has been developing for a long time with increasing integration density. However, the silicon-based semiconductor technology has recently encountered issues related to the increase in integration density, such short-channel effects and process technology limitations. A transition-metal dichalcogenide (TMDC), one of the two-dimensional materials, has structural characteristics of energy bands similar to those of silicon, and in particular, has excellent durability against short-channel effects and the advantage of reducing parasitic capacitance, and is thus attracting attention as an alternative material that may overcome the limitations of silicon-based semiconductor miniaturization.

MOSFETs are used to implement various logics through on/off state switching. MOSFETs exhibit superior characteristics the higher the on/off ratio of the current flowing through a source-drain channel.

The graph 110 on the left of FIG. 1 is a current-voltage graph in which the intrinsic component of a channel is considered without contact resistance. Referring to the graph 110 on the left, in nanometer (nm) level structures, the performance of TMDC-based MOSFETs is expected to be superior to that of silicon-based MOSFETs.

The graph 120 on the right of FIG. 1 is a current-voltage graph in which contact resistance is considered. Referring to the graph 120 on the right, unlike silicon-based MOSFETs, TMDC-based MOSFETs may have a deteriorated on/off ratio of current due to high contact resistance occurring between a three-dimensional metal (e.g., contact metal) and the two-dimensional material of the TMDC. Thus, considering the contact resistance between the two-dimensional material and a three-dimensional metal improves the accuracy of characteristics analysis and/or simulation of two-dimensional material-based MOSFETs.

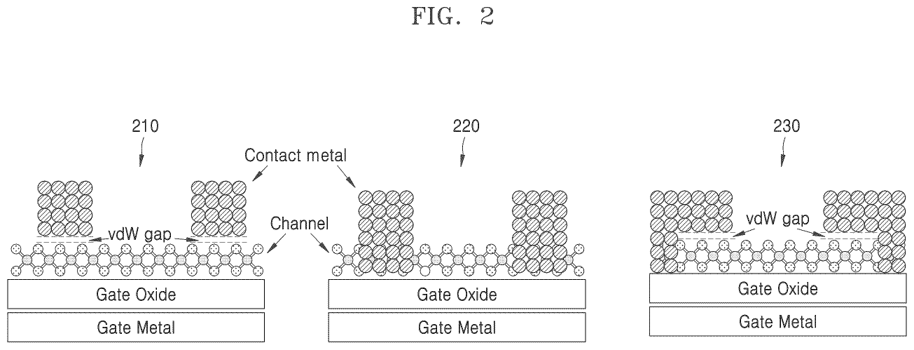

FIG. 2 illustrates contact types of example semiconductor devices according to some example embodiments.

The semiconductor devices are illustrated as bottom-gate structures; however, the example embodiments are not limited thereto. The type of contact between a two-dimensional material and a three-dimensional metal (e.g., contact metal) in a semiconductor device may include a top contact, an edge contact, or a hybrid contact.

A left diagram 210 of FIG. 2 illustrates a top contact. Referring to the left diagram 210, the top contact is a type in which a metal (e.g., contact metal) is arranged on a two-dimensional material. The metal may be stacked vertically on a layer (e.g., a surface) of the two-dimensional material (e.g., channel). There is no strong bonding between the two-dimensional material and the metal, and a van der Waals gap (vdW gap) is formed due to weak interactions between atoms. The van der Waals gap may function as a barrier (tunneling barrier) in a path through which current flows, which may increase contact resistance.

A middle diagram 220 of FIG. 2 illustrates an edge contact. Referring to the middle diagram 220, the edge contact is a type in which a metal comes into contact with an edge of a two-dimensional material. Unlike the top contact, the edge contact does not have a van der Waals gap. However, metal-induced gap states (MIGS) are formed; and the MIGS may cause a high Schottky barrier by changing the electronic state between the metal and the two-dimensional material, which may result in high contact resistance.

A right diagram 230 of FIG. 2 illustrates a hybrid contact. Referring to the right diagram 230, the hybrid contact is a type in which a top contact and an edge contact are hybridized. The hybrid contact is the most commonly used type. The hybrid contact has the characteristics of both the top contact and the edge contact.

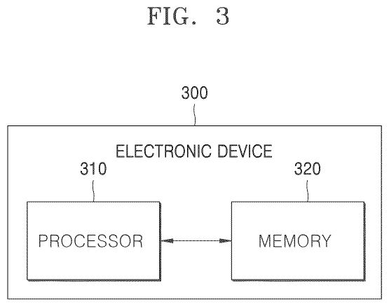

FIG. 3 is a block diagram of an electronic device 300 according to at least one example embodiment.

The electronic device 300 may include a processor 310 and a memory 320. The processor 310 and the memory 320 may be configured to communicate with each other, e.g., through a bus. Though the electronic device 300 is illustrated as including one processor 310, the example embodiments are not limited thereto; for example, the electronic device 300 may include one or more processors.

The processor 310 may be configured to control all operations of the electronic device 300. For example, the processor 310 may control all operations of the electronic device 300 to generate a current model, a contact resistance model, or a compact model of a semiconductor device or to simulate a semiconductor device by executing one or more instructions of a program stored in the memory 320. There may be one or more processors 310.

The processor 310 may be configured with processing circuitry, such as at least one of, for example, a central processing unit (CPU), a microprocessor, a graphics processing unit (GPU), an Application Specific Integrated Circuit (ASIC), a Digital Signal Processor (DSP), a Digital Signal Processing Device (DSPD), a Programmable Logic Device (PLD), a Field Programmable Gate Array (FPGA), an arithmetic logic unit (ALU), an application processor, a neural processing unit (NPU), or an artificial intelligence (AI)-only processor designed with a hardware structure specialized for processing an AI model, but is not limited thereto.

The memory 320 may store instructions, data structures, and program code that may be read by the processor 310. The operations performed by the processor 310 may be implemented by executing instructions or code of a program stored in the memory 320. For example, the memory 320 may store one or more instructions and/or programs that cause the electronic device 300 to generate a current model, a contact resistance model, or a compact model of a semiconductor device, or to simulate a semiconductor device. According to at least some example embodiments, the current model, the contact resistance model, and/or the compact model may each be generated as, for example, a data set configured as features for a DummyClassifier and/or using a structure that is trainable, e.g., with training data, such as an artificial neural network, a decision tree, a support vector machine, a Bayesian network, a genetic algorithm, and/or the like. Non-limiting examples of the trainable structure may include a convolution neural network (CNN), a generative adversarial network (GAN), an artificial neural network (ANN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

The memory 320 may include a flash memory type, a hard disk type, a multimedia card micro type, a card type memory (for example, a Secure Digital (SD) or extreme Digital (XD) memory, etc.), and/or may include a non-volatile memory including at least one of Read-Only Memory (ROM), Electrically Erasable Programmable Read-Only Memory (EEPROM), Programmable Read-Only Memory (PROM), magnetic memory, a magnetic disk, or an optical disk, and a volatile memory such as Random Access Memory (RAM) or Static Random Access Memory (SRAM).

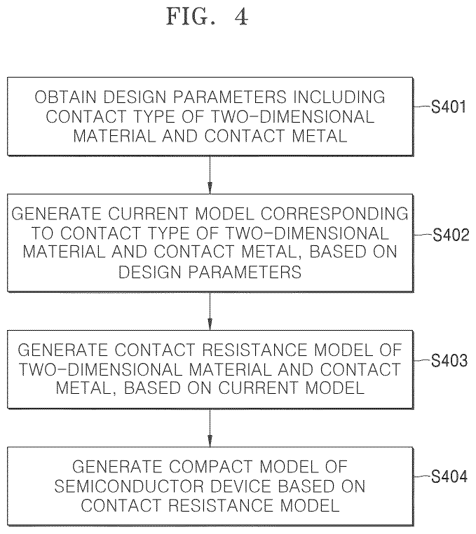

FIG. 4 is a flowchart of a method of generating a compact model of a semiconductor device, according to at least one example embodiment. The method may be performed, for example, by the electronic device 300.

A physical equation-based compact model that accurately describes the current characteristics between a source and a drain according to an external signal (voltage or current) may be applied to design a semiconductor device. To this end, a compact model of a semiconductor device, which accurately reflects the contact resistance between the two-dimensional material and the contact metal is beneficial.

In operation S401, a processor obtains design parameters including a contact type of a two-dimensional material and a contact metal.

The design parameters are parameters for designing a semiconductor device. The design parameters may include layout parameters and process parameters. For example, the layout parameters may include parameters related to the contact geometry of a two-dimensional material and a contact metal, such as contact length and/or contact area. For example, the process parameters may include processing temperatures and/or the type of contact metal.

The design parameters may vary depending on the contact type. For example, for a top contact, design parameters may include one or more of a contact area of a two-dimensional material and a contact metal, a van der Waals gap, and a Schottky barrier height. For example, for an edge contact, design parameters may include one or more of a contact length of a two-dimensional material and a contact metal and a Schottky barrier height. For example, a hybrid contact may include both the design parameters of the top contact and the design parameters of the edge contact.

The processor may generate design parameters for a semiconductor device from a layout file or from a user input. Layout files for a semiconductor device may be generated using software tools such as electronic design automation (EDA) tools. For example, the processor may extract design parameters from a layout file. Alternatively, the processor may receive design parameters from a user input.

In operation S402, the processor generates a current model corresponding to the contact type of the two-dimensional material and the contact metal, based on the design parameters.

The processor may generate a tunneling current model and a thermionic current model which correspond to the contact type of the two-dimensional material and the contact metal, respectively, and may generate a current model by integrating the tunneling current model with the thermionic current model. The known tunneling current formula and the known thermionic current formula in a contact region of a two-dimensional material and a contact metal may be used to generate the tunneling current model and thermionic current model, respectively.

Depending on the contact type, the tunneling current model and the thermionic current model may be different, and the current model may also be different accordingly.

The processor may generate a current model based on different design parameters depending on the contact type. As the independent variables of the current model, different design parameters may be used depending on the contact type.

In at least one example embodiment, the independent variables of a tunneling current model of the top contact may include a contact area of the two-dimensional material and the contact metal, a van der Waals gap, a Schottky barrier height, and a voltage applied to a semiconductor device. The independent variables of a thermionic current model of the top contact may include one or more of a processing temperature, a contact area of the two-dimensional material and the contact metal, a Schottky barrier height, and a voltage applied to a semiconductor device.

In at least one example embodiment, the independent variables of a tunneling current model of the edge contact may include a contact length of the two-dimensional material and a contact metal, a Schottky barrier height, and a voltage applied to a semiconductor device. The independent variables of a thermionic current model of the edge contact may include temperature, a contact length of the two-dimensional material and the contact metal, a Schottky barrier height, and a voltage applied to a semiconductor device.

In at least one example embodiment, a current model of the top contact may be generated by adding the tunneling current model of the top contact to the thermionic current model of the top contact. A current model of the edge contact may be generated by adding the tunneling current model of the edge contact to the thermionic current model of the edge contact. When both the top contact and the edge contact are included, a current model may be generated by adding the current model of the top contact to the current model of the edge contact.

In operation S403, the processor generates a contact resistance model of the two-dimensional material and the contact metal, based on the current model.

The contact resistance model may be generated from a current-voltage relationship of the current model generated in operation S402. Accordingly, different design parameters may be used for independent variables of the contact resistance model depending on the contact type.

In at least one example embodiment, independent variables of the contact resistance model of the top contact may include one or more of a contact area of the two-dimensional material and the contact metal, a van der Waals gap, a Schottky barrier height, and a voltage applied to a semiconductor device. Independent variables of the contact resistance model of the edge contact may include one or more of a contact length of the two-dimensional material and the contact metal, a Schottky barrier height, and a voltage applied to a semiconductor device. A contact resistance model of a hybrid contact may be generated based on the contact resistance model of the top contact and the contact resistance model of the edge contact.

In operation S404, the processor generates a compact model of the semiconductor device based on the contact resistance model.

The processor may generate the compact model of the semiconductor device based on an inherent compact model of the semiconductor device, in which contact resistance is not considered, and the contact resistance model generated in operation S403. By generating the compact model of the semiconductor device based on the contact resistance model, the response characteristics of contact resistance according to the voltage applied to the semiconductor device may be reflected in the compact model.

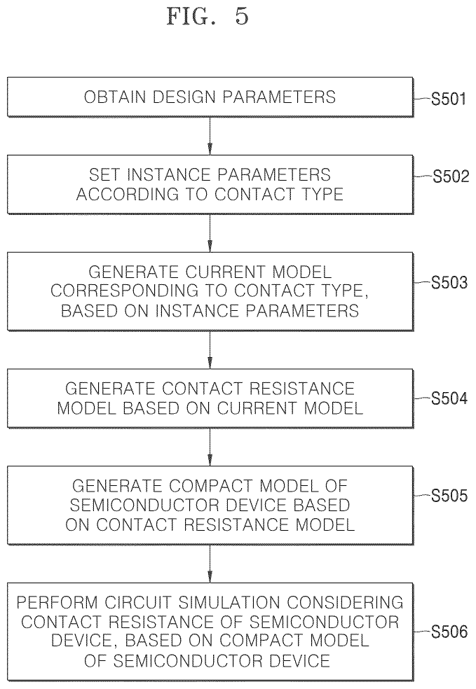

FIG. 5 is a flowchart of a method of simulating a semiconductor device, according to at least one example embodiment.

The flowchart in FIG. 5 illustrates operations of generating a compact model of a semiconductor device and performing circuit simulation. The operations of generating a compact model of a semiconductor device in the flowchart of FIG. 5 may be applied as described with reference to FIG. 4.

In operation S501, the processor obtains design parameters.

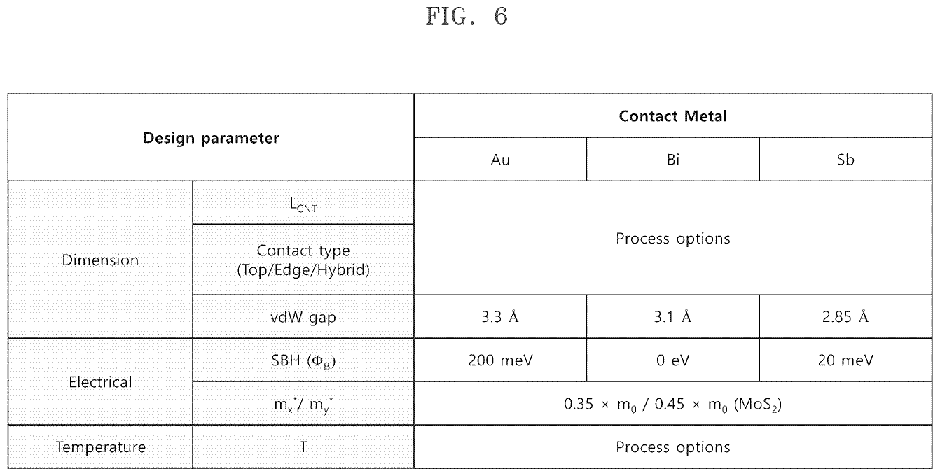

FIG. 6 illustrates examples of design parameters obtained in operation S501. Referring to FIG. 6, the design parameters may include one or more of dimension parameters, electrical parameters, temperature, and a type of a contact metal. The dimension parameters may include layout parameters, contact type, and a van der Waals gap (vdW gap) according to the type of the contact metal. The electrical parameters may include a Schottky barrier height (Φ_{B}) and an effective mass (mₓ*: effective mass in an x direction, m_{y}*: effective mass in a y direction, m₀: electron mass) according to the type of the contact metal.

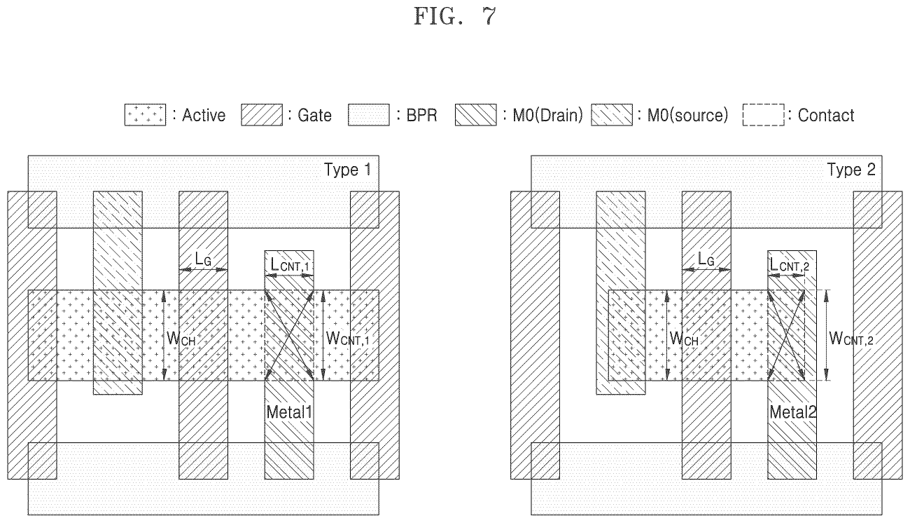

The layout parameters and the contact types are process options and may be obtained from a layout file of the semiconductor device or from a user input. FIG. 7 illustrates examples of a layout file. Referring to FIG. 7, the left diagram illustrates a layout of a semiconductor device of Type 1, and the right diagram illustrates a layout of a semiconductor device of Type 2. Layout parameters may be obtained through software tools from a layout file designed by a circuit designer. For example, the layout parameters may include a channel length, a channel width W_{CH}, a source-drain length L_{SD}, a source-drain width W_{SD}, a gate length LG, a contact length L_{CNT}, and a contact width W_{CNT}.

Referring back to FIG. 5, in operation S502, the processor sets instance parameters according to the contact type.

The processor may select instance parameters related to the contact type from the design parameters. For example, for a top contact, the instance parameters may include the contact length L_{CNT}, the contact width W_{CNT}, a van der Waals gap, an effective mass m*, a Schottky barrier height Φ_{B}, and a transmission coefficient. For example, for an edge contact, instance parameters may include the contact length L_{CNT}, the effective mass m*, and the Schottky barrier height Φ_{B}.

In operation S503, the processor generates a current model corresponding to the contact type, based on the instance parameters.

The processor may generate a tunneling current model and a thermionic current model of the top contact based on the instance parameters. Instance parameters may be used as independent variables in the current model. The tunneling current model of the top contact may be expressed as Equation 1.

$$\text{?} \text{?} = f ( {A}_{CNT} , W \text{?} , \text{?} \text{?} , {V}_{CNT} , ... ) \qquad [ Equation 1 ]$$

$$\text{?} \text{indicates text missing or illegible when filed}$$

Here, I_{top,tun} is a tunneling current of the top contact, A_{CNT} is a contact area of the top contact, W_{vdw} is a van der Waals gap, Φ_{B} is a Schottky barrier height, and V_{CNT} is a voltage of a semiconductor device, considering the contact resistance. V_{CNT} may be the voltage applied across the source and drain of the semiconductor device, considering the contact resistance.

The thermionic current model of the top contact may be expressed as Equation 2.

$$\text{?} \text{?} = f ( {A}_{CNT} , {\text{?}}_{B} , {V}_{CNT} , ... ) \qquad [ Equation 2 ]$$

$$\text{?} \text{indicates text missing or illegible when filed}$$

Here, I_{top,ther} is a thermionic current of the top contact.

The processor may generate the tunneling current model and the thermionic current model of the edge contact based on the instance parameters. The tunneling current model of the edge contact may be expressed as Equation 3.

$${\text{?}}_{edge ,} \text{?} = f ( {L}_{CNT} , {\text{?}}_{B} , {V}_{CNT} , ... ) \qquad [ Equation 3 ]$$

$$\text{?} \text{indicates text missing or illegible when filed}$$

Here, L_{edge,tun} is a tunneling current of the edge contact, and LENT is the contact length of the edge contact.

The thermionic current model of the edge contact may be expressed as Equation 4.

$${\text{?}}_{edge ,} \text{?} = f ( {L}_{CNT} , {\text{?}}_{B} , {V}_{CNT} , ... ) \qquad [ Equation 4 ]$$

$$\text{?} \text{indicates text missing or illegible when filed}$$

Here, L_{edge,ther} is a thermionic current of the edge contact.

The known tunneling current formula and the thermionic current formula may be used to generate the tunneling current model and thermionic current model of the top contact and the tunneling current model and the thermionic current model of the edge contact (e.g., Equations 1-4).

The processor may generate a current model corresponding to the contact type based on Equations 1-4. The current model of the top contact may be generated by adding the tunneling current model to the thermionic current model of the top contact. The current model of the edge contact may be generated by adding the tunneling current model to the thermionic current model of the edge contact. When both the top contact and the edge contact are included, the current model may be generated as shown in Equation 5.

$${\text{?}}_{total} = {\text{?}}_{top ,} \text{?} + {\text{?}}_{top , ther} + {\text{?}}_{edge , run} + {\text{?}}_{edge , ther} \qquad [ Equation 5 ]$$

$$\text{?} \text{indicates text missing or illegible when filed}$$

By generating a current model based on the tunneling current model and the thermionic current model, information (components, ratios, etc.) about a tunneling current and a thermionic current, which play a major role in the contact resistance of a two-dimensional material and a contact metal, may be provided.

In operation S504, the processor generates a contact resistance model based on the current model.

The processor may generate the contact resistance model from the current model generated in operation S503. The contact resistance model of the top contact may be expressed as Equation 6.

$${R}_{CNT \_ TOP} = f ( {A}_{CNT} , W \text{?} , {\text{?}}_{B} , {V}_{CNT} , ... ) \qquad [ Equation 6 ]$$

$$\text{?} \text{indicates text missing or illegible when filed}$$

Here, R_{CNT_TOP} is a contact resistance of the top contact.

The contact resistance model of the edge contact may be expressed as Equation 7.

$${R}_{CNT \_ EDGE} = f ( {L}_{CNT} , {\text{?}}_{B} , {V}_{CNT} , ... ) \qquad [ Equation 7 ]$$

$$\text{?} \text{indicates text missing or illegible when filed}$$

Here, R_{CNT_EDGE} is a contact resistance of the edge contact.

The contact resistance model of the hybrid contact may be expressed as Equation 8.

$${R}_{CNT \_ HYBRID} = f ( {R}_{CNT \_ TOP} , {R}_{CNT \_ EDGE} ) \qquad [ Equation 8 ]$$

Here, R_{CNT_HYBRID} is the contact resistance of the hybrid contact.

The contact resistance model generated in operation S504 is not a constant and is determined based on the voltage applied to the semiconductor device and the instance parameters. Thus, a sophisticated contact resistance model may be provided, which reflects design parameters such as materials selected and contact shapes designed by a circuit designer.

In operation S505, the processor generates a compact model of the semiconductor device based on the contact resistance model.

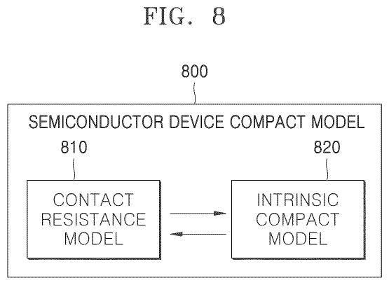

FIG. 8 illustrates a compact model of a semiconductor device, according to at least one example embodiment. Referring to FIG. 8, the processor may generate a compact model 800 of a semiconductor device, in which contact resistance is considered, based on a contact resistance model 810 generated in operation S504 and an intrinsic compact model 820. The intrinsic compact model 820 is a compact model of a semiconductor device, in which contact resistance is not considered. The intrinsic compact model 820 may be expressed as in Equations 9 and 10.

$${\text{?}}_{FET} = f ( {V}_{FET} , ... ) \qquad [ Equation 9 ]$$

$${C}_{FET} = f ( {V}_{FET} , ... ) \qquad [ Equation 10 ]$$

$$\text{?} \text{indicates text missing or illegible when filed}$$

Here, I_{FET} is a current of the semiconductor device without considering contact resistance, V_{FET} is a voltage of the semiconductor device without considering the contact resistance, and C_{FET} is a capacitance of the semiconductor device without considering the contact resistance. I_{FET} may be a source-drain current of the semiconductor device without considering contact resistance, and V_{FET} may be a source-drain voltage of the semiconductor device without considering contact resistance.

The compact model 800 may be generated by reflecting the contact resistance R_{CNT_TOP}, R_{CNT_EDGE}, or R_{CNT_HYBRID} and the voltage V_{CNT} of the contact resistance model 810 in the intrinsic compact model 820 and reflecting the current I_{FET} and the voltage V_{FET} of the intrinsic compact model 820 in the contact resistance model 810.

As the compact model 800 is based on the contact resistance model 810, the compact model 800 of the semiconductor device may be provided, in which various electrical characteristics between a two-dimensional device and a contact metal according to the design are accurately reflected. Since the contact resistance model 810 has the voltage V_{CNT} of the semiconductor device as an independent variable, the compact model 800 of the semiconductor device including response characteristics of contact resistance according to the voltage V_{CNT} of the semiconductor device may be provided.

Referring back to FIG. 5, in operation S506, the processor performs a circuit simulation, considering the contact resistance of the semiconductor device, based on a compact model of the semiconductor device. In at least some embodiments, the processor may adjust the design of the semiconductor device to meet parameters set for the semiconductor device, and/or may instruct a semiconductor device manufacturing apparatus to proceed with the manufacture of the semiconductor device in response to the circuit simulation meeting or exceeding the parameters, and thereby a circuit may be produced based on the corresponding simulated circuit layout and/or design. In at least some embodiments, the processor may be configured to further reject design parameters based on the circuit simulation (e.g., when the circuit simulation does not meet or exceed the parameters). In at least some embodiments, the processor may be configured to represent the circuit simulation. For example, in at least some embodiments, the processor may be configured to provide a visual presentation of the circuit simulation through, e.g., a Graphical User Interface (GUI), and may be configured to adjust the circuit simulation, in real-time, based on changes to the design parameters by a designer's (or user's) input. Thereby, by performing the circuit simulation, experimentation of materials, layout, and shapes for the circuit may be tested without the added cost of actually generating each of the interpretations for the circuit.

The processor may perform simulation of an electronic circuit including the semiconductor device. The processor may perform circuit simulation by using a compact model of a semiconductor device, in which the effects of contact resistance between a two-dimensional material and a contact metal are precisely reflected.

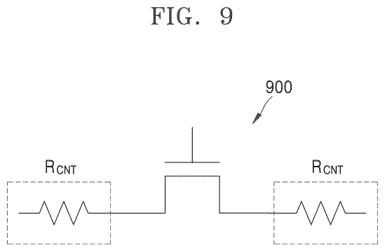

The compact model of the semiconductor device, generated in operation S505, may be used to describe the electrical characteristics of the semiconductor device in the simulation. FIG. 9 illustrates a circuit diagram of an example of a semiconductor device. Referring to FIG. 9, a compact model of a semiconductor device may be expressed as a circuit diagram 900 of a semiconductor device including a contact resistor RENT. As the circuit diagram 900 is simple, the semiconductor device may be easily connected to an electronic circuit to perform simulation of the electronic circuit.

Referring back to FIG. 5, an input voltage of the electronic circuit (e.g., VDD or a gate input voltage) may be set by a user. The voltage V_{CNT} of the contact resistance model may vary according to the input voltage of the electronic circuit, and as the contact resistance model has the voltage V_{CNT} as an independent variable, the compact model of the semiconductor device may include response characteristics of the contact resistance of the semiconductor device according to the input voltage of the electronic circuit.

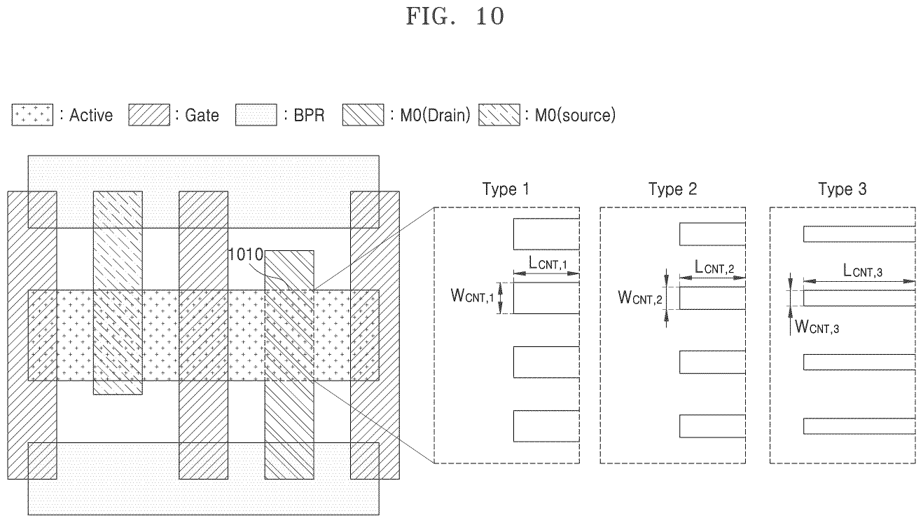

FIG. 10 illustrates application examples of the contact resistance model.

Circuit designers may design various contact shapes of a two-dimensional material and a contact metal in a contact area 1010 of a semiconductor device. FIG. 10 illustrates various contact geometries with examples of contact lengths L_{CNT,1-3} and contact widths W_{CNT,1-3}.

The contact resistance model according to the embodiments is modeled based on design parameters including layout parameters, and thus, the contact resistance may be described in detail by reflecting the contact shape of the two-dimensional material and the contact metal. Circuit designers may select a design type with the lowest contact resistance among Types 1-3 through contact resistance modeling reflecting the contact geometry.

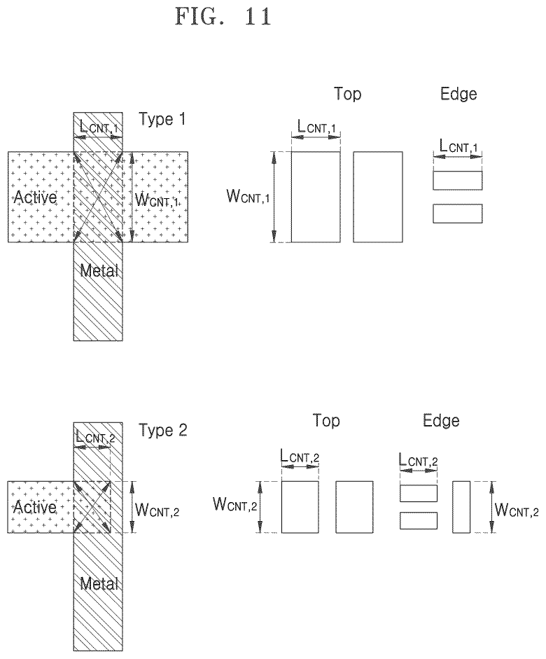

FIG. 11 illustrates application examples of a contact resistance model.

Circuit designers may compare contact resistance models between a two-dimensional material and a three-dimensional metal (e.g., a contact metal) for different layouts. Layout Type 1 has an active region wrapped by a metal and consists of two top contacts and two edge contacts. Layout Type 2 has a reduced contact length L_{CNT,2} and a reduced contact width W_{CNT,2} compared to Layout Type 1, and consists of two top contacts and three edge contacts.

The contact resistance model according to the embodiments models the resistance of a top contact by reflecting the contact area, and thus the contact resistances of Layout Type 1 and Layout Type 2 may be modeled by reflecting the different contact areas of Layout Type 1 and Layout Type 2, respectively. In addition, since the contact resistance model according to the embodiments models the resistance of an edge contact by reflecting the contact length, the contact resistances of Layout Type 1 and Layout Type 2 may be modeled respectively by reflecting the different contact lengths of Layout Type 1 and Layout Type 2. This modeling enables accurate description of contact resistance by reflecting physical characteristics according to contact geometry.

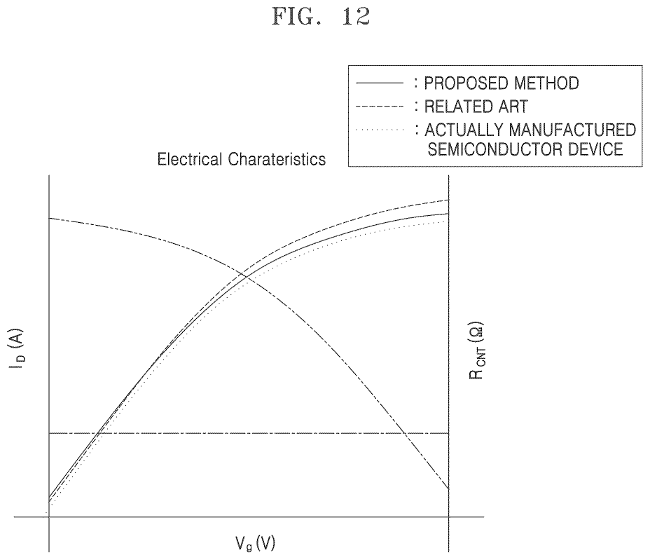

FIG. 12 illustrates performance of a compact model of a semiconductor device, according to at least one example embodiment.

FIG. 12 illustrates a graph of electrical characteristics (solid line) of a compact model of a semiconductor device based on a contact resistance model according to embodiments, a graph of electrical characteristics (dashed line) of a compact model of a semiconductor device based on a resistance model of the related art, and a graph of electrical characteristics (dotted line) of an actually manufactured semiconductor device. The compact model of the semiconductor device proposed in the disclosure precisely describes the contact resistance model, and therefore, it may be confirmed that the compact model exhibits performance closer to the electrical characteristics of an actual semiconductor device compared to the compact model of the related art.

Embodiments of the disclosure may also be implemented in the form of a recording medium including computer-executable instructions, such as program modules executed by a computer. Computer-readable media may be any available media that may be accessed by a computer, and includes both volatile and nonvolatile media and removable and non-removable media. Additionally, computer-readable media may include computer storage media and communication media. Computer storage media includes both volatile and nonvolatile, removable and non-removable media implemented in any method or technology for storage of information such as computer-readable instructions, data structures, program modules or other data. Communication media may typically include other data in a modulated data signal, such as computer readable instructions, data structures, or program modules.

Additionally, the computer-readable storage medium may be provided in the form of a non-transitory storage medium. Here, a ‘non-transitory storage medium’ means only that the medium is a tangible device and does not include a signal (e.g., electromagnetic waves), and the term does not distinguish between cases where data is stored semi-permanently or temporarily on a storage medium. For example, a ‘non-transitory storage medium’ may include a buffer in which data is temporarily stored.

The above description of the disclosure is for illustrative purposes only, and a person having ordinary skill in the art to which the disclosure pertains will understand that the disclosure may be easily modified into other specific forms without changing the technical idea or essential characteristics of the disclosure. Therefore, it should be understood that the embodiments described above are examples in all respects and not limiting. For example, each component described as a single entity may be implemented in a distributed manner, and likewise, components described as distributed may be implemented in a combined manner.

The scope of the disclosure is indicated by the claims described below rather than the detailed description above, and all changes or modifications derived from the meaning and scope of the claims and their equivalent concepts should be interpreted as being included in the scope of the disclosure.

It should be understood that the example embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electronic device configured to generate a compact model of a semiconductor device including a two-dimensional material and a contact metal, the electronic device comprising:
a memory storing one or more instructions; and
one or more processors configured to execute the one or more instructions stored in the memory,
wherein the one or more processors are configured to, by executing the one or more instructions
generate a current model based on design parameters, the design parameters including a contact type of the two-dimensional material and the contact metal and obtained from a layout file of the semiconductor device or a user input and the current model corresponding to the contact type of the two-dimensional material and the contact metal,
generate, based on the current model, a contact resistance model of the two-dimensional material and the contact metal, the contact resistance model having a voltage applied to the semiconductor device as an independent variable, and
generate, based on the contact resistance model, the compact model of the semiconductor device, the compact model including response characteristics of contact resistance of the two-dimensional material and the contact metal according to the voltage applied to the semiconductor device.

2. The electronic device of claim 1, wherein the contact type comprises at least one of a top contact in which the contact metal is contact with a surface of the two-dimensional material, an edge contact in which the contact metal is in contact with an edge of the two-dimensional material, or a hybrid contact in which the top contact and the edge contact are hybridized.

3. The electronic device of claim 1, wherein the one or more processors are configured to, by executing the one or more instructions:
generate a tunneling current model corresponding to the contact type of the two-dimensional material and the contact metal;
generate a thermionic current model corresponding to the contact type of the two-dimensional material and the contact metal; and
generate the current model from the tunneling current model and the thermionic current model.

4. The electronic device of claim 1, wherein the one or more processors are configured to, by executing the one or more instructions, generate the current model based on layout parameters regarding a contact shape of the two-dimensional material and the contact metal,
wherein the layout parameters comprise at least one of a contact length or a contact area of the two-dimensional material and the contact metal.

5. The electronic device of claim 1, wherein the one or more processors are configured to, by executing the one or more instructions, generate the current model based on the design parameters differentiated according to the contact type.

6. The electronic device of claim 1, wherein the one or more processors are configured to, by executing the one or more instructions, generate the contact resistance model based on the design parameters differentiated according to the contact type.

7. The electronic device of claim 6, wherein, the contact type of the two-dimensional material and the contact metal includes a top contact, and the design parameters comprise a van der Waals gap, a Schottky barrier height, and a contact area of the two-dimensional material and the contact metal.

8. The electronic device of claim 6, wherein, the contact type of the two-dimensional material and the contact metal includes an edge contact, and the design parameters comprise a Schottky barrier height and a contact length of the two-dimensional material and the contact metal.

9. The electronic device of claim 1, wherein the two-dimensional material comprises a transition metal dichalcogenide.

10. The electronic device of claim 1, wherein the contact metal comprises at least one of a single material or a compound.

11. A method, performed by one or more processors, of generating a compact model of a semiconductor device including a two-dimensional material and a contact metal, the method comprising:
generating a current model based on design parameters, the design parameters including a contact type of the two-dimensional material and the contact metal and obtained from at least one of a layout file of the semiconductor device or a user input, and the current model corresponding to the contact type of the two-dimensional material and the contact metal;
generating, based on the current model, a contact resistance model of the two-dimensional material and the contact metal, the contact resistance model having a voltage applied to the semiconductor device as an independent variable; and
generating, based on the contact resistance model, the compact model of the semiconductor device, the compact model including response characteristics of contact resistance of the two-dimensional material and the contact metal according to the voltage applied to the semiconductor device.

12. The method of claim 11, wherein the contact type comprises at least one of a top contact in which the contact metal is in contact with a surface the two-dimensional material, an edge contact in which the contact metal is in contact with an edge of the two-dimensional material, or a hybrid contact in which the top contact and the edge contact are hybridized.

13. The method of claim 11, wherein the generating the current model comprises:
generating a tunneling current model corresponding to the contact type of the two-dimensional material and the contact metal;
generating a thermionic current model corresponding to the contact type of the two-dimensional material and the contact metal; and
generating the current model from the tunneling current model and the thermionic current model.

14. The method of claim 11, wherein the generating the current model comprises generating the current model based on layout parameters regarding a contact shape of the two-dimensional material and the contact metal,
wherein the layout parameters comprise at least one of a contact length or a contact area of the two-dimensional material and the contact metal.

15. The method of claim 11, wherein the generating of the current model comprises generating the current model based on the design parameters differentiated according to the contact type.

16. The method of claim 11, wherein the generating of the contact resistance model comprises generating the contact resistance model based on the design parameters differentiated according to the contact type.

17. The method of claim 16, wherein, the contact type of the two-dimensional material and the contact metal includes a top contact, and the design parameters comprise a van der Waals gap, a Schottky barrier height, and a contact area of the two-dimensional material and the contact metal.

18. The method of claim 16, wherein, the contact type of the two-dimensional material and the contact metal includes an edge contact, and the design parameters comprise a Schottky barrier height and a contact length of the two-dimensional material and the contact metal.

19. The method of claim 11, wherein the two-dimensional material comprises a transition metal dichalcogenide.

20. A computer-readable recording medium having recorded thereon a program for causing a computer to execute the method of claim 11.
